(19) United States
(12) Patent Application Publication
(10) Pub. No.: US 2025/0370322 A1
(43) Pub. Date: Dec. 4, 2025

(54) PROJECTION DEVICE AND ILLUMINATION SYSTEM

(71) Applicant: QISDA CORPORATION, Taoyuan City (TW)

(72) Inventor: Ching-Tze Huang, Taoyuan City (TW)

(73) Assignee: QISDA CORPORATION, Taoyuan City (TW)

(21) Appl. No.: 19/014,173

(22) Filed: Jan. 8, 2025

(30) Foreign Application Priority Data
May 31, 2024 (CN) 202410697968.8

(51) Int. Cl. G03B 21/20

(52) U.S. Cl. CPC G03B 21/204

(57) ABSTRACT

A projection device is applied to an illumination system and includes a circuit board, a light source module and a wavelength conversion component. The light source module is disposed on the circuit board and adapted to emit an illumination beam. The light source module includes at least one light emitting diode and at least one laser unit arranged adjacent to each other. A total luminous of the light source module is ranged between 0.5 square millimeters and 10 square millimeters. The wavelength conversion component is disposed on the light source module. A laser illumination range of the laser unit is partly overlapped with a light emitting diode illumination range of the light emitting diode to increase an illumination intensity of a central area of the illumination beam, and an illumination intensity of a peripheral area of the illumination beam is lower than the illumination intensity of the central area.

### BACKGROUND OF THE INVENTION

### 1. Field of the Invention

The present invention relates to a projection device and an illumination system, and more particularly, to a projection device and an illumination system with high luminous efficiency and low production cost.

### 2. Description of the Prior Art

A conventional illumination system usually has plural light emitting diode arranged as an array, or plural laser unit arranged as the array for being the illumination light source. The light emitting diode has low luminous efficiency and low production cost, the laser unit has high luminous efficiency and concentrated energy, but is more expensive than the light emitting diode. If the illumination system has high brightness requirements, the illumination light source made by the laser unit has a drawback of high hardware cost, and the illumination light source made by the light emitting diode has a drawback of insufficient brightness. Therefore, design of an illumination system with high luminous efficiency and low production cost is an important issue in the related illumination industry.

### SUMMARY OF THE INVENTION

The present invention provides a projection device and an illumination system with high luminous efficiency and low production cost for solving above drawbacks.

According to the claimed invention, a projection device includes a circuit board, a light source module and a wavelength conversion component. The light source module is disposed on the circuit board and adapted to emit an illumination beam. The light source module includes at least one light emitting diode and at least one laser unit arranged adjacent to each other, and a total luminous area of the light source module is ranged between 0.5 square millimeters and 10 square millimeters. The wavelength conversion component is disposed on the light source module. A laser illumination range of the laser unit is partly overlapped with a light emitting diode illumination range of the light emitting diode for increasing an illumination intensity of a central area of the illumination beam, and an illumination intensity of a peripheral area of the illumination beam around the central area is lower than the illumination intensity of the central area.

According to the claimed invention, the light emitting diode and the laser unit respectively are rectangular units, an outer contour of adjacent arrangement of the light emitting diode and the laser unit is a rectangle. The light emitting diode and the laser unit are disposed on the circuit board in a co-planar manner. A luminous area of the laser unit is smaller than fifty percent of the total luminous area, a luminous area of the light emitting diode is greater than or equal to fifty percent of the total luminous area. The light source module further includes the laser unit and two light emitting diodes, the two light emitting diodes are respectively disposed on two opposite sides of the laser unit. At least one of the light emitting diode and the laser unit is covered by the wavelength conversion component. The wavelength conversion component allows penetration of some part of the illumination beam, and is excited by other part of the illumination beam to generate an excitation beam.

According to the claimed invention, an illumination system includes an imaging element, an optical element assembly, a light valve and a projection device. The light valve is disposed between the imaging element and the optical element assembly. The projection device is disposed on a side of the optical element assembly opposite to the light valve. The projection device includes a circuit board, a light source module and a wavelength conversion component. The light source module is disposed on the circuit board and includes at least one light emitting diode and at least one laser unit arranged adjacent to each other. A total luminous area of the light source module is ranged between 0.5 square millimeters and 10 square millimeters, and an illumination beam emitted by the light source module passes the optical element assembly, the light valve and the imaging element in sequence. The wavelength conversion component is disposed on the light source module. A laser illumination range of the laser unit is partly overlapped with a light emitting diode illumination range of the light emitting diode for increasing an illumination intensity of a central area of the illumination beam, and an illumination intensity of a peripheral area of the illumination beam around the central area is lower than the illumination intensity of the central area.

The projection device and the illumination system of the present invention can dispose the light emitting diode and the laser unit on the circuit board for setting as the light source module, and the light emitting diode and the laser unit can be activated simultaneously or alternately to emit the illumination beam. The laser illumination range of the laser unit can be partly overlapped with the light emitting diode illumination range of the light emitting diode, so the illumination beam provided by the light source module can have the central area with high illumination intensity and the peripheral area with low illumination intensity. The projection device can provide the light source module with the rectangular light-emitting surface because the light emitting diode and the laser unit are arranged adjacent to each other as the rectangle in the co-planar manner. The projection device and the illumination system of the present invention can be preferably applied for the car headlight. Comparing to the prior art, the present invention can have advantages of high luminous efficiency and low hardware cost, and can quickly switch the array-arranged light source module to comply with adaptive design of the car headlight.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an illumination system according to an embodiment of the present invention.

FIG. 2 is a diagram of a projection device according to the embodiment of the present invention.

FIG. 3 is a diagram of an illumination result of the projection device according to the embodiment of the present invention.

FIG. 4 is a diagram of the projection device according to another embodiment of the present invention.

### DETAILED DESCRIPTION

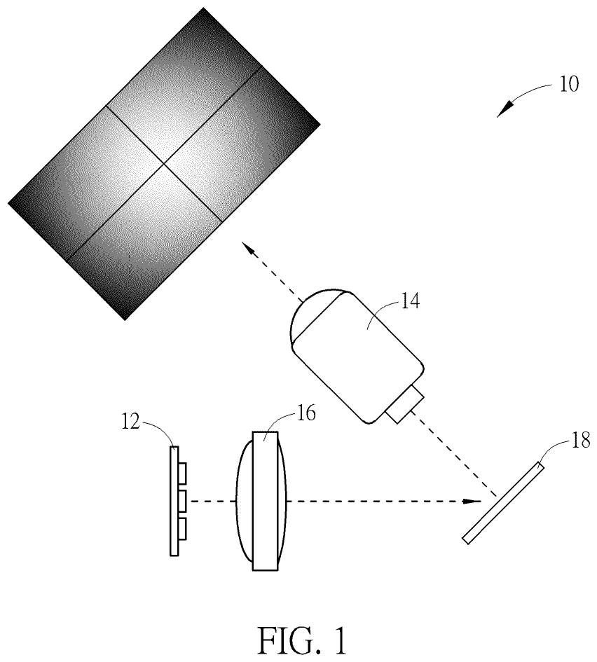

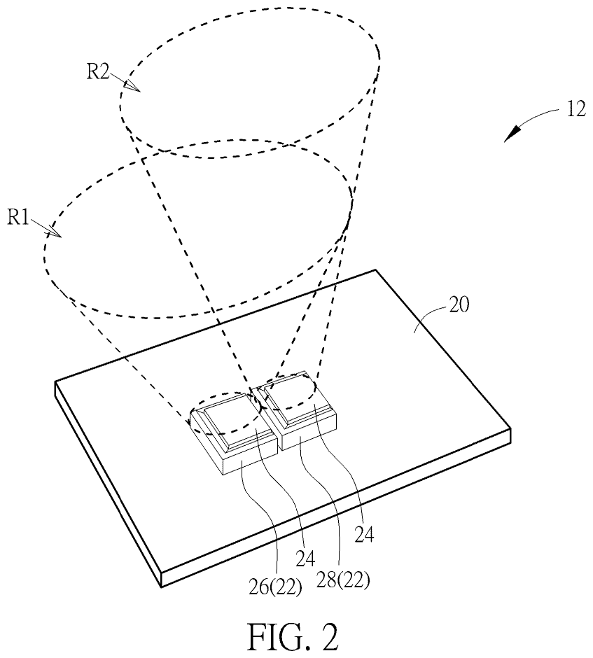

Please refer to FIG. 1 and FIG. 2. FIG. 1 is a diagram of an illumination system 10 according to an embodiment of the present invention. FIG. 2 is a diagram of a projection device 12 according to the embodiment of the present invention. The illumination system 10 can be a projector apparatus, or any apparatus with high luminous requirements. The illumination system 10 can include the projection device 12, an imaging element 14, an optical element assembly 16 and da light valve 18. The imaging element 14 can be a common camera lens, and its standard and function are omitted herein for simplicity. The optical element assembly 16 can include one or plural optical elements, such as a lens or a reflector, and variation of the optical elements can depend on a design demand. The light valve 18 can be used to transform an illumination beam provided by the projection device 12 into an image beam, and the image beam can be transformed into a projection beam via the imaging element 14 for projection. The light valve 18 can be disposed between the imaging element 14 and the optical element assembly 16; actual structure of the light valve 18 can depend on the design demand.

The projection device 12 can be disposed on a side of the optical element assembly 16 opposite to the light valve 18, and include a circuit board 20, a light source module 22 and a wavelength conversion component 24. The light source module 22 can be disposed on the circuit board 20. The wavelength conversion component 24 can be located above the light source module 22. The light source module 22 can include a light emitting diode 26 and a laser unit 28 arranged adjacent to each other. Numbers and arrangement of the light emitting diode 26 and the laser unit 28 are not limited to the embodiment shown in the figures, and depend on the design demand. The light emitting diode 26 can have features of low luminous efficiency and low hardware cost. The laser unit 28 can have features of high luminous efficiency and high hardware cost. The present invention can provide the light source module 22 having the light emitting diode 26 and the laser unit 28 for the projection device 12, and the projection device 12 can have advantages of high luminous efficiency and low hardware cost.

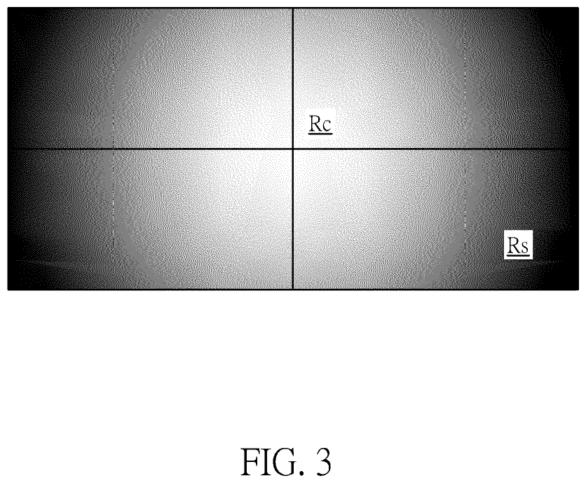

Please refer to FIG. 2 and FIG. 3. FIG. 3 is a diagram of an illumination result of the projection device 12 according to the embodiment of the present invention. In the embodiment, the light emitting diode 26 and the laser unit 28 can be disposed on the circuit board 20 in a co-planar manner. A light emitting diode illumination range R1 of the light emitting diode 26 can be partly overlapped with a laser illumination range R2 of the laser unit 28. The light emitting diode illumination range R1 and the laser illumination range R2 can refer to cone patterns shown in FIG. 2, and the illumination result of the light emitting diode illumination range R1 and the laser illumination range R2 overlapped with each other can be shown in FIG. 3. The present invention can increase an illumination intensity of a central area Rc of the illumination beam, and an illumination intensity of a peripheral area Rs of the illumination beam around the central area Rc can be lower than the illumination intensity of the central area Rc, so as to form the light source module 22 with high central illumination but low peripheral illumination.

In addition, the light emitting diode 26 and the laser unit 28 can be preferably designed as rectangular units, and an outer contour of adjacent arrangement of the light emitting diode 26 and the laser unit 28 can be designed as a rectangle accordingly; practical application of shapes of the light emitting diode 26 and the laser unit 28 is not limited to the foresaid embodiment. A total luminous area of the light source module 22 (such as an area of the rectangular outer contour of the adjacent arrangement of the light emitting diode 26 and the laser unit 28) can be ranged between 0.5 square millimeters and 10 square millimeters; actual values of the foresaid range can depend on the size of the light source module 22. A luminous area of the light emitting diode 26 (which means an area of the rectangular unit) can be preferably greater than or equal to fifty percent of the total luminous area, and a luminous area of the laser unit 28 (which means an area of the rectangular unit) can be preferably smaller than fifty percent of the total luminous area, so as to effectively avoid excessive concentration of energy when the luminous efficiency of the light source module 22 is increased.

Besides, the wavelength conversion component 24 may cover the light emitting diode 26 and/or the laser unit 28. The wavelength conversion component 24 can allow penetration of some part of the illumination beam, and be excited by other part of the illumination beam to generate an excitation beam. For example, the illumination beam may be a blue light beam; some of the blue light beam can pass through the wavelength conversion component 24, and other blue light beam can be transformed into the excitation beam as a yellow light beam via the wavelength conversion component 24, then the excitation beam can be mixed with the blue light beam that passes through the wavelength conversion component 24 to form a white light beam as the image beam and the projection beam. Further, the illumination beam may be set as the white light beam, and the wavelength conversion component 24 can be optionally removed from the light source module 22.

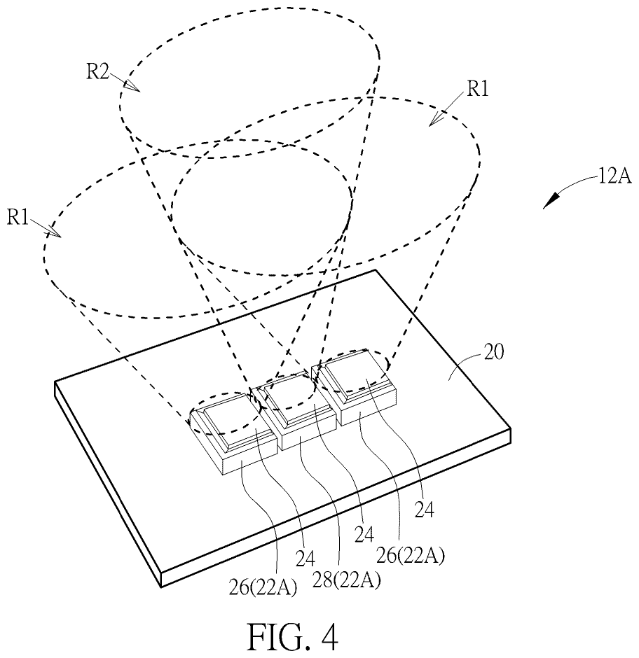

Please refer to FIG. 4. FIG. 4 is a diagram of the projection device 12A according to another embodiment of the present invention. In the embodiment, elements having the same numerals as ones of the foresaid embodiment can have the same structures and functions, and a detailed description is omitted herein for simplicity. The light source module 22A of the projection device 12A can further include a plurality of light emitting diodes 26 and the laser unit 28. The plurality of light emitting diodes 26 can be disposed around the laser unit 28 in a symmetrical manner. For example, the light source module 22A may include two light emitting diodes 26, and the two light emitting diodes 26 can be respectively disposed on two opposite sides of the laser unit 28. The wavelength conversion component 24 can optionally cover at least one of the light emitting diodes 26 and the laser unit 28.

As the embodiment shown in FIG. 4, the total luminous area of the light source module 22A can be ranged between the 0.5 square millimeters and 10 square millimeters. The total luminous area of the two light emitting diodes 26 can be preferably greater than or equal to fifty percent of the total luminous area of the light source module 22A. The luminous area of the laser unit 28 can be preferably smaller than fifty percent of the total luminous area of the light source module 22A. The light source module 22A can increase the illumination intensity of the central area Rc of the illumination beam, and the illumination intensity of the peripheral area Rs of the illumination beam around the central area Rc can be smaller than the illumination intensity of the central area Rc, so as to form the light source module 22A with high central illumination but low peripheral illumination.

In conclusion, the projection device and the illumination system of the present invention can dispose the light emitting diode and the laser unit on the circuit board for setting as the light source module, and the light emitting diode and the laser unit can be activated simultaneously or alternately to emit the illumination beam. The laser illumination range of the laser unit can be partly overlapped with the light emitting diode illumination range of the light emitting diode, so the illumination beam provided by the light source module can have the central area with high illumination intensity and the peripheral area with low illumination intensity. The projection device can provide the light source module with the rectangular light-emitting surface because the light emitting diode and the laser unit are arranged adjacent to each other as the rectangle in the co-planar manner. The projection device and the illumination system of the present invention can be preferably applied for the car headlight. Comparing to the prior art, the present invention can have advantages of high luminous efficiency and low hardware cost, and can quickly switch the array-arranged light source module to comply with adaptive design of the car headlight.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection device comprising:
a circuit board;
a light source module disposed on the circuit board and adapted to emit an illumination beam, the light source module comprising at least one light emitting diode and at least one laser unit arranged adjacent to each other, and a total luminous area of the light source module being ranged between 0.5 square millimeters and 10 square millimeters; and
a wavelength conversion component disposed on the light source module;
wherein a laser illumination range of the laser unit is partly overlapped with a light emitting diode illumination range of the light emitting diode for increasing an illumination intensity of a central area of the illumination beam, and an illumination intensity of a peripheral area of the illumination beam around the central area is lower than the illumination intensity of the central area.

2. The projection device of claim 1, wherein the light emitting diode and the laser unit respectively are rectangular units, an outer contour of adjacent arrangement of the light emitting diode and the laser unit is a rectangle.

3. The projection device of claim 1, wherein the light emitting diode and the laser unit are disposed on the circuit board in a co-planar manner.

4. The projection device of claim 1, wherein a luminous area of the laser unit is smaller than fifty percent of the total luminous area, a luminous area of the light emitting diode is greater than or equal to fifty percent of the total luminous area.

5. The projection device of claim 1, wherein the light source module further comprises the laser unit and two light emitting diodes, the two light emitting diodes are respectively disposed on two opposite sides of the laser unit.

6. The projection device of claim 1, wherein at least one of the light emitting diode and the laser unit is covered by the wavelength conversion component.

7. The projection device of claim 1, wherein the wavelength conversion component allows penetration of some part of the illumination beam, and is excited by other part of the illumination beam to generate an excitation beam.

8. An illumination system, comprising:
an imaging element;
an optical element assembly;
a light valve disposed between the imaging element and the optical element assembly; and
a projection device disposed on a side of the optical element assembly opposite to the light valve, the projection device comprising:
a circuit board;
a light source module disposed on the circuit board and comprising at least one light emitting diode and at least one laser unit arranged adjacent to each other, a total luminous area of the light source module being ranged between 0.5 square millimeters and 10 square millimeters, an illumination beam emitted by the light source module passing the optical element assembly, the light valve and the imaging element in sequence; and
a wavelength conversion component disposed on the light source module;
wherein a laser illumination range of the laser unit is partly overlapped with a light emitting diode illumination range of the light emitting diode for increasing an illumination intensity of a central area of the illumination beam, and an illumination intensity of a peripheral area of the illumination beam around the central area is lower than the illumination intensity of the central area.

9. The illumination system of claim 8, wherein the light emitting diode and the laser unit respectively are rectangular units, an outer contour of adjacent arrangement of the light emitting diode and the laser unit is a rectangle.

10. The illumination system of claim 8, wherein the light emitting diode and the laser unit are disposed on the circuit board in a co-planar manner.

11. The illumination system of claim 8, wherein a luminous area of the laser unit is smaller than fifty percent of the total luminous area, a luminous area of the light emitting diode is greater than or equal to fifty percent of the total luminous area.

12. The illumination system of claim 8, wherein the light source module further comprises the laser unit and two light emitting diodes, the two light emitting diodes are respectively disposed on two opposite sides of the laser unit.

13. The illumination system of claim 8, wherein at least one of the light emitting diode and the laser unit is covered by the wavelength conversion component.

14. The illumination system of claim 8, wherein the wavelength conversion component allows penetration of some part of the illumination beam, and is excited by other part of the illumination beam to generate an excitation beam.

15. The illumination system of claim 8, wherein the light emitting diode and the laser unit are activated simultaneously or alternately so that the light source module emits the illumination beam.
